(19) United States
(12) Patent Application Publication
(10) Pub. No.: US 2010/0095985 A1
(43) Pub. Date: Apr. 22, 2010

(54) STEAM CLEANER AND METHOD FOR STEAM CLEANING

(75) Inventor: Peter Teerlink, Rotterdam (NL)

Correspondence Address: Fleit Gibbons Gutman Bongini & Bianco PL, 21355 EAST DIXIE HIGHWAY, SUITE 115, MIAMI, FL, 33180, US

(73) Assignee: INNOCLEANING MAGMA HOLDING B.V., Capelle aan den IJssel (NL)

(21) Appl. No.: 12/531,100

(22) PCT Filed: Mar. 13, 2007
(86) PCT No.: PCT/IB2007/050846

§ 371 Date: Dec. 22, 2009

(51) Int. Cl. B08B 7/00; A47L 7/00

(52) U.S. Cl. 134/19; 15/320

(57) ABSTRACT

Steam cleaner, comprising a water tank, heating means for forming steam, at least one connecting socket for a steam hose, a receiving tank for waste and a suction device for sucking waste into said receiving tank, wherein the receiving tank is provided with at least one inlet for steam into said receiving tank.

The invention relates to a steam cleaner. Steam cleaners are known and for example marketed as DeepClean® by Osprey Deepclean Nederland BV, Capelle aan de IJssel.

Steam cleaners can be used for cleaning artefacts such as products, surfaces of floors, walls or ceilings, equipment and the like. To clean these artefacts different utensils can be used, which can be coupled to a steam hose connected to or part of said steam cleaner. Preferably movable steam cleaners are used, such as portable steam cleaners or steam cleaners on wheels.

An object of the present invention is to provide a steam cleaner which can even better clean artefacts or which can be used for an even greater variety of artefacts, surfaces and other cleanable objects.

In a first aspect a steam cleaner of the present invention can be characterized by comprising a water tank, heating means for forming steam, at least one connecting socket for a steam hose, a receiving tank for waste and a suction device for sucking waist into said receiving tank, wherein the receiving tank is provided with at least one inlet for steam into said receiving tank.

In a second aspect a steam cleaner of the present invention can be characterized by comprising a water tank, heating means for forming steam and at least one connecting socket for a steam hose, wherein furthermore a toolbox is provided which is provided with at least one inlet for steam into said toolbox.

It has been recognized in the present application that although steam cleaners can in general clean artefacts such as products, surfaces and the like accurately, the utensils used with such steam cleaners are a source for bacteria and other contaminations. They are used on different artefacts and bacteria and other contaminations will gather in and on said utensils during use, which can be transferred from one artefact to another. They can be cleaned in between, for example by rinsing or brushing, but this is cumbersome and does not always lead to clean utensils.

In the present invention a tank or box is provided with the steam cleaner, in which the utensils can be cleaned using steam generated with said steam cleaner. The utensils can be thoroughly cleaned at hand and can even be sterilized on site, resulting in a reduction of contamination and preventing transfer of contamination.

It should be recognized that the tank or box can be part of the steam cleaner, for example the receiving tank for waste, but can also be a separate tank or box, which can be attached to or carried with a steam cleaner.

In a further aspect a steam cleaner can be characterized by at least one steam hose is provided, having a first end for cooperation with the at least one socket and an opposite second end provided with a coupler for coupling to the at least one inlet.

The steam hose can be connected to the inlet for steam into the receiving tank of tool box, for cleaning and preferably sterilizing said utensils inside said box or tank. Alternatively a (semi) permanent connection can be provided between said steam generating means such as the heating means and the tank or box, provided with a steam regulator in said connection for controlling the inlet of steam.

In a still further aspect the present invention can be characterized by a method for cleaning for cleaning artefacts, wherein at least one artefact is cleaned using a steam cleaner with at least one cleaning utensil, wherein after cleaning at least part of said artefact said at least one cleaning utensil is positioned in a tool box or receiving tank, wherein steam generated with said steam cleaner is introduced into said tool box or receiving tank.

In a still further aspect the invention relates to a method for cleaning artefacts using a steam cleaner, wherein said artefact is positioned within a receiving tank or tool box, after which steam is generated with said steam cleaner and is introduced into said tank or box for cleaning and preferably sterilizing said artefact.

In the sub claims further advantageous embodiments are disclosed.

For a better understanding of the invention different embodiments will be described hereafter, as examples and in no way limiting the invention, with reference to the drawings. Therein:

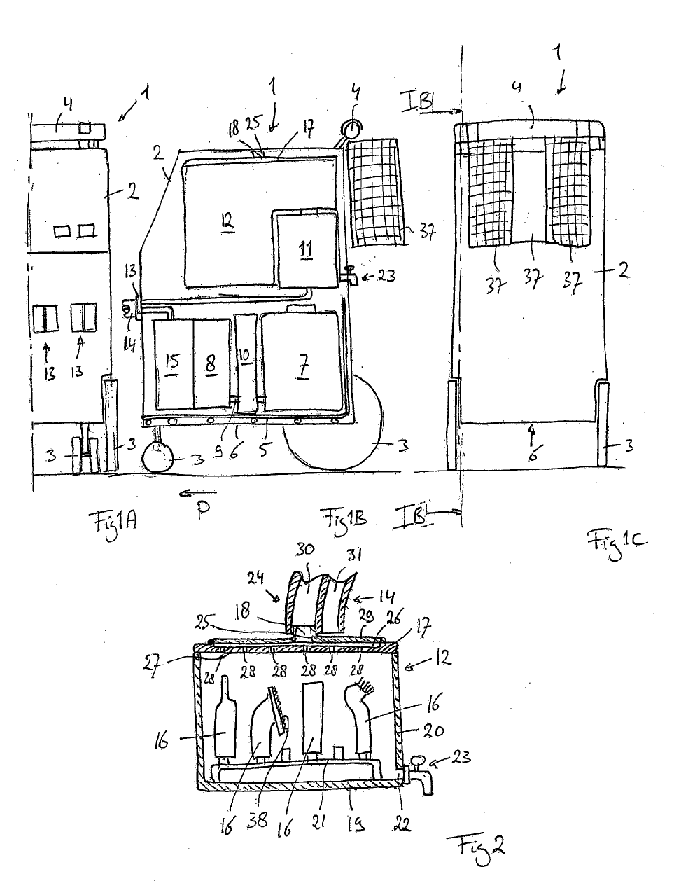

FIG. 1A shows schematically in frontal view part of a steam cleaner;

FIG. 1B shows schematically in side view a steam cleaner, with a side partially broken away along the line IB-IB in FIG. 1C;

FIG. 1C shows a steam cleaner according to FIGS. 1A and B, in rear view;

FIG. 2 shows, partially in cross section, in side view schematically a receiving tank of a steam cleaner, with part of a steam hose having two channels;

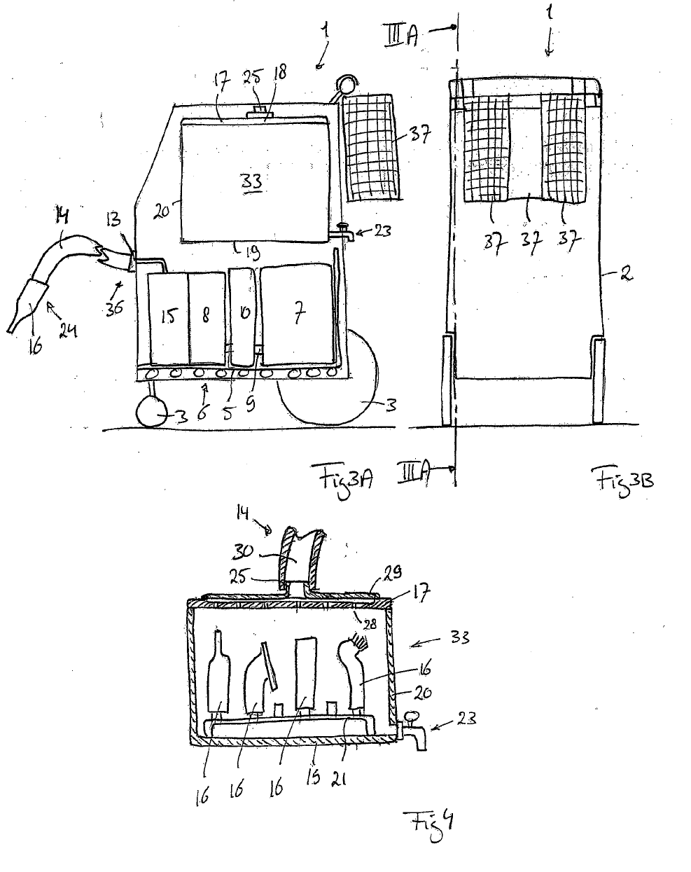

FIG. 3A shows schematically in side view a second embodiment of a steam cleaner, with a side partially broken away along the line IIIA-IIIA in FIG. 3B;

FIG. 3B shows a steam cleaner according to FIG. 3A, in rear view;

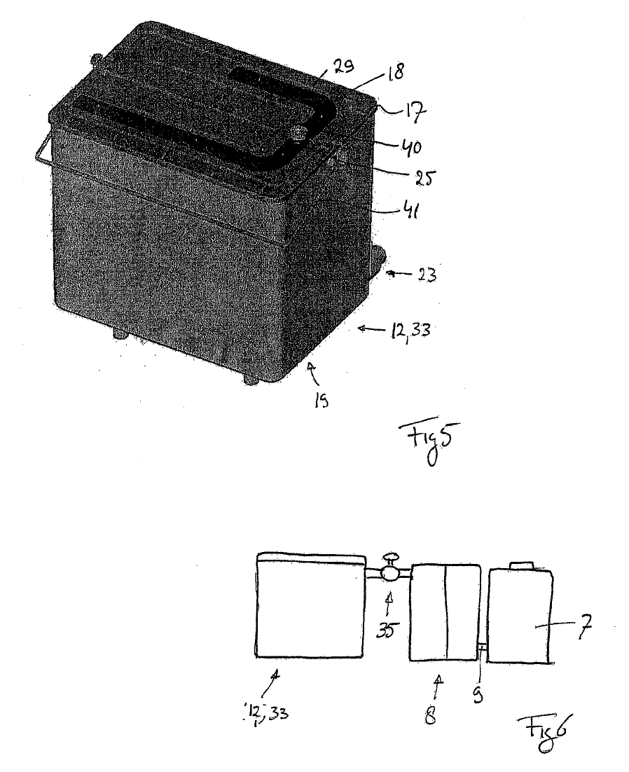

FIG. 4 shows, partially in cross section, in side view schematically a tool box for a steam cleaner, with part of a steam hose;

FIG. 5 shows in perspective view a receiving tank or tool box;

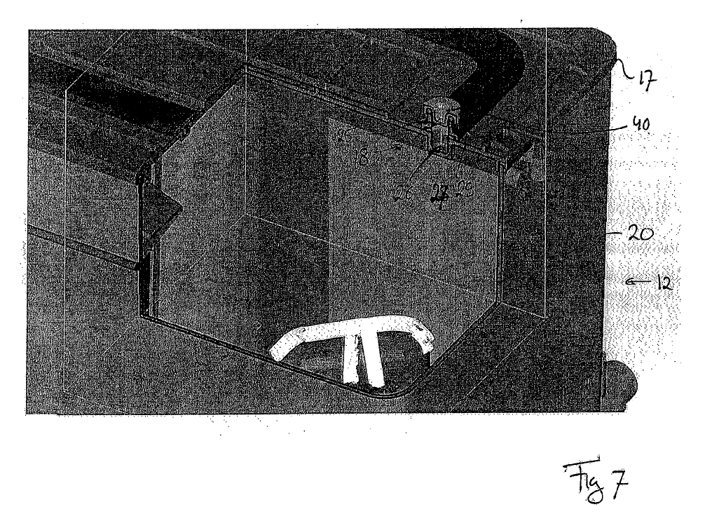

FIG. 6 shows part of a steam cleaner, connecting the receiving tank or tool box and the steam generating means; and

FIG. 7 shows a detail of an inlet of a tank or box according to FIG. 5.

The embodiments shown and described hereafter are only presented as examples of the invention and should by no means be considered limiting the scope of the present invention. Many variants are possible within the scope of the present invention. In the embodiments shown identical or similar parts have the same or similar reference signs. Combinations of parts of the embodiments shown are also considered to have been disclosed.

In this application artefact has to be understood as encompassing but not limited to products, machines, tools, utensils, constructions and other material objects at least partly made by man, including but not limited to furniture such as tables, chairs, cup boards and beds, mattresses and cushions, carpentry, window decoration, utensils such as cutlery and tools, flooring such as floor boards, carpets and plastic flooring, ceilings and walls and other materials.

In this application steam has to be understood as including but not limited to dry and wet steam, overheated steam, steam including additives such as cleaning agents, disinfectants, anti bacterial agents, odorants and the like, although steam made of clear water is preferred, which steam is preferably at a pressure and temperature for sterilizing.

In FIG. 1A-C in respectively front, side and rear view a steam cleaner 1 is shown, in FIG. 1B partially in cross section, comprising a housing 2 carried on wheels 3, such that it can be rolled around. A pushing bar 4 may be provided for pushing and/or pulling of the steam cleaner 1 around. Within the housing 2 a drawer like sliding element 5 is provided near a bottom 6, in which sliding element 5 a water tank 7 and heating means 8 are provided, in fluid connection by a connector 9 in a known manner, suitable for inserting water from the water tank 7 into the heating means 8 for heating said water, such that it can be transferred into steam. An electronic control box 10 is furthermore provided on said sliding element 5, for controlling inter alia the heating means 8. Such steam generating means are generally known and for example used in the referenced Deepclean® steam cleaner, incorporated herein by reference for the at least the steam generating means. By placing these elements 7, 8, 9, 10 in the sliding element they can easily be slid out of said housing in the direction P for maintenance, for example cleaning or repairs and/or for filling the water tank 7. The elements and further electronically controlled elements in the steam cleaner 1 are preferably interconnected by connectors that can easily and readily be unplugged and re-plugged, such that each component can be exchanged easily, should such be necessary, for example when a failure occurs, such that the down time of the steam cleaner can be minimized or even avoided.

Within the housing furthermore suction means 11 and a receiving tank 12 are provided. Furthermore at least one connecting socket 13 for connecting a steam hose 14 is provided, which is or can be brought into fluid connection with both the suction means 11 and a steam tank 15 provided within housing 2, in fluid connection with the heating means 8, such that steam can be pressurized in said steam tank 12 and can be expelled through said socket 13 and said steam hose 14, for cleaning an artefact. By the suction means 11 dirt collected from the artefact can be sucked into the receiving tank 12, together with at least part of the steam which will have condensed or otherwise liquefied on or near said artefact.

Tests have shown that artefacts as indicated before and others can be thoroughly cleaned using steam, and can even be sterilized. However, it has been proven that tools or utensils 16 used with such steam cleaner 1 can for a source for infection or transfer of dirt, bacteria and other undesirables, since these themselves are not sufficiently cleaned. Especially in environments where cleanliness is essential, such as clean rooms, hospitals and other such areas, but also in kitchens, toilets and the like, therefore it is essential that clean cleaning utensils 16 are used.

In the steam cleaner 1 the receiving tank 12 is provided with a lid 17 and at least one inlet 18 for steam into said receiving tank 12. This inlet 18 may also be referred to as steam inlet 18. In FIGS. 2, 5 and 7 such receiving tank 12 is shown in more detail, in partial cross section. The tank 12 comprises a bottom 19, a wall 20 and a lid 17, wherein said inlet 18 is provided in said lid, although this could also be provided elsewhere, for example in said wall, preferably close to said lid or at least close to an upper part of said tank 12. A rack 21 is provided which can fit inside said tank 12, preferably resting on said bottom 19 or made integral with said tank 12, although preferably said rack can be removed from said tank 12. An outlet opening 22 is provided, preferably near said bottom 19, for draining said receiving tank 12, preferably provided with a closure 23 such as a tap. The receiving tank 12 can thus be drained from waste such as any liquid material such as water mixed with dirt as received from the suction means 11. On the rack 21 cleaning utensils 16 can be placed, such as but not limited to utensils 16 as used with the steam cleaner 1, for example suitable for attaching to an end 24 of the steam hose 14 for cleaning artefacts. Also smaller artefacts could be placed on said rack 21. The rack together with the utensils 16 and/or artefacts can then be placed inside said receiving tank 12 (once drained), after which the lid 17 can be closed and steam can be generated and introduced onto said tank 12 through said inlet 18, for cleaning and preferably sterilizing said utensils and/or said artefacts inside said receiving tank 12. Preferably the tank 12 can be hermetically sealed during such cleaning and/or sterilizing. Then the utensils and/or artefacts can be removed and reused. Thus in an easy manner sterile utensils 16 such as cleaning tools and artefacts can be obtained and the risk of transfer is minimized. A tool box described hereafter can be of the same or similar construction.

As is shown in FIG. 2 the end 24 of the steam hose 14 can be connected to a connector 25 on the lid 17, such that steam can easily be generated by the steam cleaner and be introduced into said tank 12 through said inlet 18. As is shown in FIGS. 2 and 7 the inlet 18 can comprise a slot 26 in the lid, having a bottom 27 in which a series of openings 28 is provided. A cover, shown as a closing strip 29 is provided over said slot 26, closing it off. The connector 25, which can be closable by a cap 40, can be attached to the strip 29. The slot 26 shown can have a substantially U-shaped configuration, for distributing the steam more evenly through the tank 12 or tool box 33 as will be described later, which can have a similar configuration. A lifting means such has a hanger 41 can be provided for easy lifting of the tank 12 or box 33.

In a steam cleaner 1 according to FIGS. 1 and 2 the steam hose 14 has at least two channels 30, 31. A first channel 30 is provided for leading steam to and/or through a utensil or tool 16, the other channel 31 is provided for connecting to the suction means 11, for sucking up waste, dirt water and the like and dumping this into the receiving tank 12. In a steam cleaner 1 two sockets 13 can be provided, for attaching two steam hoses 14, such that no utensils 16 have to be changed or at least less frequently. More or only one such socket 13 could be provided.

In FIG. 6 part of an embodiment is shown in which the receiving tank 12 and the steam generating means 7, 8, 10 are connected directly, wherein a valve 35, preferably electrically operable, is provided for letting steam into the receiving tank 12 or tool box 33. A tool box may also be partly or entirely flexible.

In FIGS. 3A and B a steam cleaner 1 is shown comparable to the one according to FIG. 1, but having no suction means. In this embodiment a steam hose 14 can be inserted into or is connected to the or a socket 13 and can have only the first channel 30. In this embodiment a tool box 33 is provided, comparable to a receiving tank 12 as shown and described above, in which the same or similar reference signs have been used for similar parts. This tool box 33 may have means 22 for draining. A rack 21 is or can be provided inside the tool box 33, for carrying utensils and/or relatively small artefacts, as described with reference to the receiving tank 12. In this embodiment the tool box can be integrated in the steam cleaner 1 or can be provided separate, such that it can for example be placed on top of the housing 2 or next to the steam cleaner. It may also be used with different and/or various steam cleaners.

In FIG. 4 a tool box 33 is shown, partially in cross section, in which an end 24 of the steam hose 14 is connected to the inlet 18 of a tool box 33, which steam hose 14 is connected to the steam generating means with the opposite end 36. Steam generated with the steam cleaner 1 can be inserted into the tool box 33 for cleaning and/or sterilizing the utensils and/or artefacts.

A steam cleaner 1 is for example suitable for cleaning a series of surfaces of furniture, such as mattresses or cushions, wherein utensils such as steam cleaning tools 16 can be cleaned or even sterilized in situ, such that transfer of contamination such as bacteria is prevented. In the same manner various other artefacts can be cleaned in series.

In FIGS. 1 and 2 a number of receptacles 37 is provided, attached to the housing 2 or the bar 4, for receiving utensils and/or tools 16 and/or cloth 38 such as micro fibre cloth for use with the steam cleaner 1, which may also be cleaned in the receiving tank 12 or tool box 33. The receptacles may be detachable and for example foldable.

The present invention is by no means limited to the embodiments shown and described. Many variations are possible within the scope of the invention as claimed. For example, the receiving tank 12 and/or tool box 33 may be designed differently, for different tools or utensils. Moreover, they may be designed such that a tool or utensil 16 attached to a hose 14 can be inserted for cleaning and/or sterilization. Different lids 17 and/or tanks 12 and/or boxes 33 may be provided, for example rigid or flexible, and they could be coupled directly or indirectly to the hose 14. Moreover, a disposable or reusable container such as a cup or bag could be provided for attachment to the end of the hose, in which artefacts, tools and/or utensils could be cleaned and preferably sterilised and possibly stored for later use. Inlets 18 may be designed differently and may be exchangeable, for example such that for different tools, utensils and/or artefacts different inlets can be provided, each defining a proper distribution of steam inside said tank 12 or box 33. A steam cleaner may be portable, for example provided with straps or a frame for carrying such or may be stationary. The rack 21 could be dispensed with, the tools being inserted directly into said box 33 or tank 12. The housing could be open at for example a top side for approach of the tank 12 or box 33, but could also be provided with a lid or other cover for protection.

1. Steam cleaner, comprising a water tank, heating means for forming steam, at least one connecting socket for a steam hose, a receiving tank for waste and a suction device for sucking waste into said receiving tank, wherein the receiving tank is provided with at least one inlet for steam into said receiving tank.

2. Steam cleaner, comprising a water tank, heating means for forming steam and at least one connecting socket for a steam hose, wherein furthermore a toolbox is provided which is provided with at least one inlet for steam into said toolbox.

3. Steam cleaner according to claim 1, wherein said receiving tank is said tool box.

4. Steam cleaner according to claim 1, wherein said receiving tank and/or toolbox is provided with a lid, wherein said at least one inlet is provided in or near said lid.

5. Steam cleaner according claim 1, wherein the receiving tank and/or toolbox is provided with a series of inlets.

6. Steam cleaner according to claim 1, wherein at least one steam hose is provided, having a first end for cooperation with the at least one socket and an opposite second end provided with a coupler for coupling to the at least one inlet.

7. Steam cleaner according to claim 1, wherein the receiving tank is provided with an outlet opening, preferably provided with a closure.

8. Steam cleaner according to claim 1, wherein cleaning utensils are provided for connecting to said at least one socket, preferably via a steam hose, or for use with said steam cleaner separately, wherein at least one of said utensils can be placed inside said receiving tank and/or said tool box.

9. Steam cleaner according to claim 8, wherein a rack is provided for placement inside said receiving tank and/or said tool box, on or in which rack at least one of said utensils can be placed.

10. Steam cleaner according to claim 1, wherein the receiving tank and/or said tool box is provided with a slot in a wall part such as a wall or a lid, wherein said slot is covered by a cover, the at least one inlet being provided in or on said slot for introducing steam between said slot and said cover.

11. Steam cleaner according to claim 1, wherein at least two connecting sockets are provided.

12. Steam cleaner according to claim 1, wherein the steam cleaner comprises a housing, whereby the water tank is provided on and/or in a sliding element, such that by sliding said sliding element at least the water tank can be brought out of said housing.

13. Steam cleaner according to claim 12, wherein a control device is provided for at least said heating means, which control device is at least partly provided in or on said sliding element.

14. Steam cleaner according to claim 1, wherein at least one receptacle is provided for receiving cloth.

15. Steam cleaner according to claim 1, wherein a connector is provided between said heating means or steam generating means and said receiving tank or tool box for introducing said steam into said tank or box.

16. Method for cleaning artefacts, wherein at least one artefact is cleaned using a steam cleaner with at least one cleaning utensil, wherein after cleaning at least part of said artefact said at least one cleaning utensil is positioned in a tool box or receiving tank, wherein steam generated with said steam cleaner is introduced into said tool box or receiving tank.

17. Method according to claim 16, wherein steam is introduced into said tank or box after hermetically closing it.

18. Method according to claim 16, wherein said utensils are positioned in or on a rack within said tank or box, such that they are positioned above a bottom thereof

19. Method for cleaning artefacts using a steam cleaner, wherein said artefact is positioned within a receiving tank or tool box, after which steam is generated with said steam cleaner and is introduced into said tank or box for cleaning and preferably sterilizing said artefact.

20. Set of a steam cleaner according to claim 1 and a set of utensils for said steam cleaner, wherein at least a number of said utensils can be received with the receiving tank or tool box of said steam cleaner.

21. Receiving tank or tool box, comprising at least one steam inlet.
